(19) United States
(12) Patent Application Publication
(10) Pub. No.: US 2025/0197283 A1
(43) Pub. Date: Jun. 19, 2025

(54) SYNTHETIC GYPSUM FILLER BASED JOINT COMPOUND WITH LOW COEFFICIENT OF FRICTION

(71) Applicant: United States Gypsum Company, Chicago, IL (US)

(72) Inventors: David Daniel Pelot, Chicago, IL (US); Tyler Jared Kincaid, Wheaton, IL (US); Phanindra Kodali, Mundelein, IL (US); Scott Daryl Cimaglio, Grayslake, IL (US); Naveen Punati, Kildeer, IL (US)

(21) Appl. No.: 18/804,466

(22) Filed: Aug. 14, 2024

Related U.S. Application Data
(63) Continuation-in-part of application No. 18/804,284, filed on Aug. 14, 2024.
(60) Provisional application No. 63/609,437, filed on Dec. 13, 2023.

(51) Int. Cl. C04B 14/36; C04B 11/02; C04B 11/26; C04B 14/10; C04B 20/00; C04B 26/02; C04B 111/00

(52) U.S. Cl. CPC C04B 14/365; C04B 11/02; C04B 11/262; C04B 14/102; C04B 14/106; C04B 20/008; C04B 26/02; C04B 2111/00681

(57) ABSTRACT

A drying-type joint compound and related methods, the drying-type joint compound having a lowered friction coefficient and formulated with chloride-containing flue-gas-desulfurization (FGD) gypsum powder having the median particle size (D50) of at least about 20 μm, preferably the chloride-containing FGD gypsum powder having a D10 greater than 5 μm, wherein the drying-type joint compound further comprises a binder; one or more clays; a cellulosic thickener; and an additive.

### CROSS-REFERENCE TO RELATED APPLICATIONS

This application is a continuation-in-part application of U.S. patent application Ser. No. 18/804,284 filed Aug. 14, 2024, which claims the benefit of priority to U.S. provisional patent application 63/609,437 filed Dec. 13, 2023, the entire disclosure of both applications is herein incorporated by reference.

### TECHNICAL FIELD

This disclosure relates to the field of building construction compositions and methods, including drying-type joint compounds having a lowered friction coefficient.

### BACKGROUND

Gypsum panels including drywall panels are commonly used in construction of interior walls and ceilings. In order to build a wall, gypsum panels may be affixed to a frame with fasteners. Various joint compounds are then used in order to finish seams (joints) between adjacent gypsum panels.

Joint compounds include setting-type joint compounds which comprise calcined gypsum as a main filler and drying-type joint compounds which may comprise calcium carbonate as a main filler. A joint compound is mixed with water to form a paste which is then spread over a drywall surface and joints. After the applied joint compound dries, it may need to be sanded.

Various attempts have been made to improve sandability of a joint compound. For example, U.S. Pat. No. 10,928,286 discloses a system and method for determining a sandability value of a joint compound. U.S. Pat. No. 7,048,791 discloses a low dust wall repair compound which comprises one or more of airborne dust reducing additives including oils, surfactants, solvents, waxes, and other petroleum derivatives. U.S. Pat. Nos. 10,800,706 and 10,988,416 disclose vesicle dedusting agents for joint compounds and methods.

Yet, there remains the need in the field for drying-type joint compounds that would be relatively easy to sand, in particular the need remains for formulating drying-type joint compounds with components such as synthetic gypsum that has been synthesized by environmentally conscientious methods in which production of wastewater has been minimized.

### SUMMARY

This disclosure provides drying-type joint compounds formulated with chloride-containing flue-gas-desulfurization (FGD) gypsum powder having the median particle size (D50) of at least about 20 μm, more preferably at least about 30 μm, and most preferably at least about 40 μm, as measured with a dynamic light scattering analyzer. These drying-type joint compounds have a technical advantage of a lowered friction coefficient in comparison to drying-type joint compounds formulated with natural gypsum having the median particle size (D50) of about 15 μm and a further technical advantage of being formulated with the FGD gypsum synthesized by methods in which generation of wastewater has been minimized.

In one aspect, this disclosure provides a drying-type joint compound composition comprising:
a) chloride-containing flue-gas-desulfurization (FGD) gypsum powder having the median particle size (D50) of at least about 20 μm;
b) a binder;
c) one or more clays;
d) a cellulosic thickener; and
e) an additive.

Preferably, the drying-type joint compounds include those, wherein the median particle size (D50) is measured in a dynamic light scattering analyzer and wherein the drying-type joint compound composition when mixed with water and allowed to dry has a friction coefficient lower than a friction coefficient of a drying-type joint compound comprising natural gypsum having the median particle size (D50) of about 15 μm.

In embodiments, the chloride-containing FGD gypsum powder may comprise one or more of the following chloride salts: calcium chloride, magnesium chloride, sodium chloride, potassium chloride and/or any combination thereof. In embodiments of the drying-type joint compound composition, the chloride-containing FGD gypsum powder may contain from about 500 PPM to about 20,000 PPM of chloride. Some embodiments of the drying-type joint compound composition may include those, wherein the chloride-containing FGD gypsum powder is obtained by a method comprising:
a) oxidizing an aqueous chloride-containing slurry comprising calcium sulfite into chloride-containing FGD gypsum slurry, and
b) dewatering the chloride-containing FGD gypsum slurry produced in step a) into dewatered chloride-containing FGD gypsum,
wherein the method is performed without a step of lowering the chloride concentration. Preferably, the method may further comprise removing fine particles from the chloride-containing FGD gypsum powder.

In embodiments of the drying-type joint compound composition, the additive may include a polymeric additive selected from one or more of the following: a surfactant, redispersible powdered latex, dispersing agent, humectant, defoaming agent, a plasticizer, polyethylene oxide, a phospholipid, or any combination thereof.

In embodiments of the drying-type joint compound composition, the chloride-containing FGD gypsum powder may have the D50 value in the range from about 20 μm to about 80 μm.

Particularly preferred embodiments of the drying-type joint compound composition include those, wherein the chloride-containing FGD gypsum powder is in an amount ranging from about 50 wt % to about 95 wt % on a dry basis of the drying-type joint compound composition; or the drying-type joint compound composition further comprises calcium carbonate. In the embodiments, wherein the chloride-containing FGD gypsum powder is in combination with calcium carbonate, the combination of the two components may comprise from about 50 wt % to about 95 wt % on a dry basis of the dry-type joint compound composition. In some preferred embodiments, if calcium carbonate is present, then calcium carbonate and the chloride-containing FGD gypsum powder may be used in a ratio ranging from 0.1:10 to 10:1 by weight, respectively.

Preferred embodiments of the drying-type joint compound composition include those, wherein the drying-type joint compound composition comprises on a dry basis:
about 50 wt % to about 95 wt % of the chloride-containing FGD gypsum powder;
about 0.5 wt % to about 15 wt % of the binder;
about 1 wt % to about 10 wt % of the one or more clays;
about 0.05 wt % to about 3 wt % of the cellulosic thickener; and
about 0.1 wt % to about 3 wt % of the additive comprising one or more of
the following: acrylic rheological modifier, biocide, pigment, fungicide, dispersing agent, humectant, defoaming agent, plasticizer, dedusting agent, starch, or any combination thereof.

In embodiments, the drying-type joint compound composition may further comprise one or more of the following light-weight fillers: perlite, expanded perlite, coated expanded perlite, mica, hollow glass microspheres, talc, polyethylene hollow microspheres, ceramic microspheres, solid glass microspheres, plastic microspheres, or any mixture thereof. Particularly preferred embodiments include those, wherein the one or more of the light-weight fillers are used in an amount from about 0.5 wt % to about 25 wt % on a dry basis of the drying-type joint compound.

Preferred embodiments of the drying-type joint compound composition include those, wherein the chloride-containing FGD gypsum powder comprises about 0.04 wt % to about 1.5 wt % chloride by weight.

In embodiments, the drying-type joint compound composition may further comprise one or more of the following dedusting agents: a wax, oil, polyethylene glycol, glycerol, siloxane, or any combination thereof.

Embodiments of the drying-type joint compound composition may include those, wherein the binder is a latex binder with a high glass transition temperature (Tg).

Embodiments of the drying-type joint compound composition include those, wherein the drying-type joint compound composition further comprises one or more of ASE and/or HASE rheological modifiers.

In another aspect, this disclosure relates to a ready-mixed drying-type joint compound, wherein the ready-mixed drying-type joint compound comprises the drying-type joint compound composition according to this disclosure and water in the following amounts:
about 25.0-67.0 wt % of the chloride-containing FGD gypsum powder containing about 0.04-1.5 wt % of chloride;
about 0.1-5.0 wt % of the binder;
the one or more clays comprising about 0.5-5.0 wt % attapulgite clay and about 0.1-3.0 wt % of kaolin clay;
about 0.1-0.6 wt % of the cellulosic thickener;
about 0.1-2.0 wt % of the additive; and
about 25.0-55.0 wt % water, preferably seawater.

In yet another aspect, this disclosure relates to a method for producing flue-gas-desulfurization (FGD) gypsum powder for use in a drying-type joint compound, the method comprising: dewatering a slurry comprising chloride-containing FGD gypsum into dewatered chloride-containing FGD gypsum, wherein the resulting chloride-containing FGD gypsum powder contains from about 500 PPM to about 20,000 PPM of chloride.

### BRIEF DESCRIPTION OF THE DRAWINGS

FIG. 1 is a schematic side view of one embodiment of a system for measuring a friction coefficient for a joint compound according to this disclosure.

FIG. 2 is a table reporting results of a comparative analysis comparing a friction coefficient in drying-type joint compounds comprising gypsum powder according to this disclosure in comparison to formulations comprising gypsum, calcium carbonate, or synthetic gypsum.

FIG. 3 is a chart reporting results of a comparative analysis comparing a friction coefficient in drying-type joint compounds comprising gypsum powder according to this disclosure in comparison to formulations which comprise various additives, such as dedusting agents and/or different binders.

FIG. 4 is a schematic of a system for producing unwasted FGD gypsum according to this disclosure, in which production of wastewater is minimized.

FIG. 5 is a schematic of a method for producing unwashed FGD gypsum according to this disclosure.

### DETAILED DESCRIPTION

In this disclosure, “wt %” means percentage by weight. In this disclosure, all percentages and ratios are by weight, unless specifically stated otherwise.

In this disclosure, “about” means a value plus/minus 10%. For example, “about 100” means 100±10 and “about 200” means 200±20.

In this disclosure, the term “composition” may be used interchangeably with the term “mixture” or “formulation.” Compositions include dry powder formulations which do not comprise water or liquid components as well as compositions in liquid, slurry or paste form which comprise water and/or liquid components.

In this disclosure, “seawater” means the water sourced from an ocean or sea and comprising about 96.5% water and about 2.5% salts which are mainly sodium and chloride ions.

In this disclosure, “a dry joint compound composition” means that the composition does not contain aqueous water or liquid components. Preferably, the composition may be in powder form. However, a dry composition or dry mixture may have some moisture content and may contain compounds with bound water molecules.

In this disclosure, “dry component” means a component which does not comprise aqueous water or liquid additives. The dry component may have some moisture content and may contain bound water molecules.

In this disclosure “by wt % on a dry basis of the composition” means by weight of dry components, not including aqueous water or liquid components.

In this disclosure, the term “gypsum” may refer to any of the following: naturally mined gypsum (ore), landplaster and/or synthetic gypsum. Gypsum may also include gypsum which originates from a waste stream, as a by-product, or a recycled material, such as recycled dry wall. The term “gypsum” may be used interchangeably with the term “calcium sulfate dihydrate” or CaSO₄·2H₂O.

The “synthetic gypsum” may be also referred to as “chemical gypsum,” or flue-gas-desulfurization (FGD) gypsum.

In this disclosure, “PPM” stands for “parts per million” which is a unit of measurement used to definite a concentration of a substance in a sample. The PPM value may be calculated as follows: the substance mass (m) divided by the total mass (M) of the sample, and then multiplying the resulting m/M value by one million.

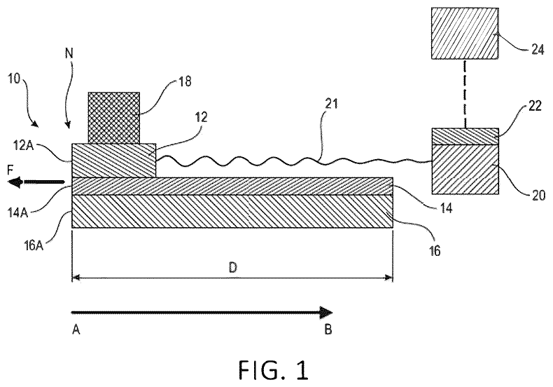

Referring to FIG. 1, in this disclosure, a friction coefficient (u) is defined as the ratio of the friction force (F) resisting a motion in direction from A to B of a sanding surface (12) in contact with a dried joint compound to be sanded (14), the dried joint compound (14) being applied over a surface (16), to the normal force (N) pressing the two surfaces (12 and 14) together, the normal force (N) being applied by a weight (18) pressing over the two surfaces (12 and 14) together. The friction coefficient (u) is defined by formula (I):

$$μ = \frac{F}{N} ,$$

wherein F is the friction force and N is the normal force

In formula (I), F and N are measured in Newtons and accordingly, the friction coefficient (μ) has no measurement units.

Still referring to FIG. 1 which depicts a side view of one embodiment for a system for measuring a friction coefficient (μ), generally (10). The friction coefficient (μ) may be calculated by measuring the friction force (F) using the system (10) in which a joint compound to be tested is applied to a certain thickness, e.g., 0.62 mm thickness, over a surface (16), preferably the surface being a wallboard, and most preferably the wallboard being 4 inches by 12.25 inches panel. The applied drying-type joint compound is allowed to dry, thereby producing a dried joint compound (14) to be tested. Preferably, the joint compound (14) is applied on a 4″×12.25″ wallboard panel at a 0.62 mm thickness, with a 2.5″ width and a 12.25″ length.

A sanding surface (12) such as for example as sanding paper, preferably 150 grit sandpaper and most preferably 10×9 cm size 150 grit sandpaper is then placed over the dried joint compound (14) by aligning one an edge (14A/16A) of the dried compound to be sanded (14) with an edge (12A) of the sanding surface (12). A weight (18) of a known value, for example a 1500 g weight, is then placed over the sanding surface (12), pressing the two surfaces (12 and 14) together and generating normal force (N) in the direction shown with an error.

The sanding surface (12) is connected to a means (20) with a wire, rope or chain (21). A force is then applied to the sanding surface (12) by means (20) sufficient to drug the sanding surface (12) in direction from A to B over the dried joint compound surface (14) for a distance (D). The means (20) is connected to a force gauge (22). The force gauge (22) measures a resistance force (F) resisting a motion of the sanding surface (12) in direction from A to B. The force gauge (22) may be optionally in communication with a processor (24) which process force values received from the force gauge (22) and computes the friction coefficient (u) of a sample according to formula (I).

One suitable system for measuring the friction coefficient (u) includes a system and method for evaluating a joint compound specimen disclosed in U.S. Pat. No. 10,928,286, the entire disclosure of which is herein incorporated by reference.

In this disclosure, the term “calcined gypsum” may be used interchangeably with calcium sulfate hemihydrate, stucco, calcium sulfate semi-hydrate, calcium sulfate half-hydrate, plaster of Paris, or CaSO₄·1/2H₂O.

When calcined gypsum (CaSO₄·1/2H₂O) is mixed with water into a slurry or paste, calcined gypsum hydrates and sets into a gypsum matrix. This setting reaction can be described by the following equation:

CaSO₄·1/2H₂O+3/2H₂O→CaSO₄·2H₂O

In this disclosure, the term “limestone” may be used interchangeably with calcium carbonate or CaCO₃.

In this disclosure, the median particle size of gypsum powder may be abbreviated as “D50.” The median particle size of gypsum, D50 may be measured by a laser diffraction (scattering) method, preferably using isopropyl alcohol as dispersant. D50 is the median diameter particle size with 50% of counted particles having larger diameters (sizes) and 50% of counted particles having smaller diameters (sizes). In this disclosure, measurements were performed on Horiba LA950V2 dynamic light scattering analyzer from HORIBA, Ltd. (Japan) using isopropyl alcohol as dispersant at room temperature of about 21° C. Particles in the gypsum powder according to this disclosure may be further characterized with D10 and D90 values. D10 is defined as a particle size on a particle size distribution curve below which 10% of particles have a smaller particle size and above which 90% of particles have a larger size. D90 is defined as a particle size on the particle size distribution curve below which ninety percent of particles have a smaller particle size and above which ten percent of particles have a larger particle size.

In this disclosure “a composition is substantially free of fine particles” means that the composition comprises less than about 5%, less than about 2%, or less than about 1% of fine particles, e.g., between about 0.01% to about 5% of fine particles having a size of about 5 μm, or smaller.

In this disclosure, the term “chloride” may refer to a negatively charged chlorine ion (Cl⁻) ionically bonded to a cation in a in a crystalline lattice of a water soluble compound, including chloride salts in their anhydrous as well as in various hydrate forms, sodium chloride, potassium chloride, calcium chloride and/or magnesium chloride, each and all salts in anhydrous form and/or as hydrates, for example magnesium chloride includes anhydrous MgCl₂ and/or MgCl₂XnH₂O, wherein is n is in the range from 1 to 12.

In the drying-type joint compounds according to this disclosure, synthetic (FGD) gypsum may include an industrial by-product generated during combustion of sulfur-containing fuels such as coal or oil, for example in a coal-fired power plant. Particularly preferred FGD gypsum may include unwashed FGD gypsum containing one or more chloride salts.

FGD gypsum is a by-product of selective oxidation of sulfite (S⁻²) to sulfate (SO₄⁻²) in the presence of Ca⁺² in flue gas, resulting from combustion of coal. This reaction may be conducted in a scrubber and in an oxidation reactor where the flue gas is sprayed with limestone slurry and aerated. The scrubber system may be located immediately after the coal combustion chamber.

As FGD gypsum is synthesized, a concentration for other salts, including chloride salts, may also increase, including from sources such as recycled water, a limestone slurry, and/or the coal. There are limits to the chloride level which can be tolerated in the scrubber. Corrosion-resistant porcelain or other non-corrosive scrubbers can handle high levels in the range of 35,000 ppm chloride, while non-coated or non-corrosion resistant scrubbers can corrode at 12,000 ppm chloride.

Dewatered gypsum may have up to 10% water (non-chemically bound, “free water”). Consequently, levels of chloride could reach up to 4 g/kg, or roughly 4,000 PPM chloride. When a counter ion is sodium, the sodium chloride level may be roughly 6,600 PPM.

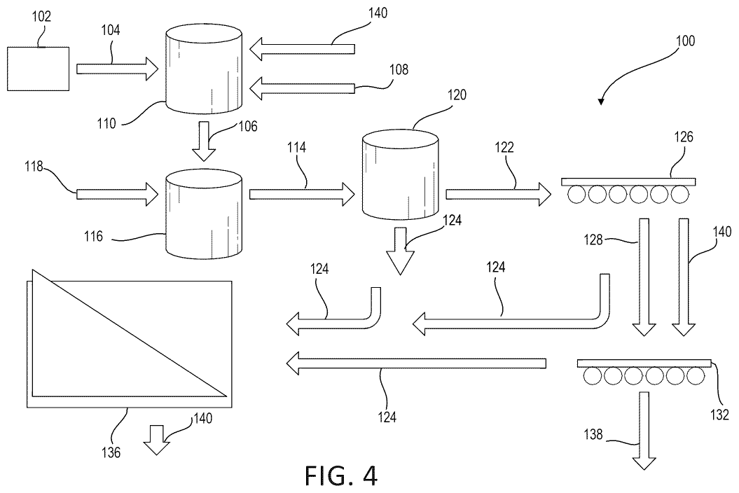

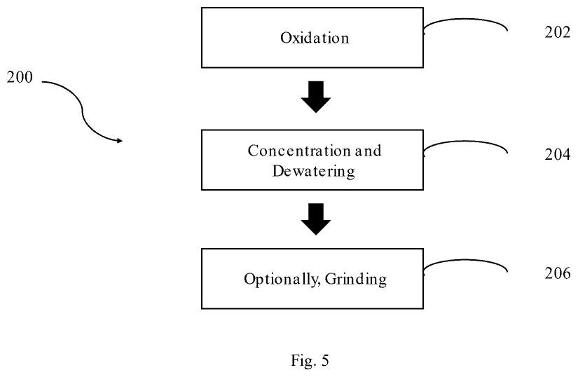

The FGD gypsum according to this disclosure may be produced by a sulfur dioxide scrubbing method, one embodiment of which, generally (200), is depicted in FIG. 5. One embodiment of a system for producing the FGD gypsum according to this disclosure, generally (100) is depicted in FIG. 4. In the system (100), the unwashed FGD gypsum (114) may be produced by wet-scrubbing sulfur dioxide (SO₂, 104) generated in a coal combustion process (102). This unwashed FGD gypsum (114) may comprise chloride ions (Cl⁻) and/or various chloride salts in anhydrous and/or hydrated forms, including, but not limited to, calcium chloride, magnesium chloride, sodium chloride and/or potassium chloride.

In the system (100), the gaseous sulfur dioxide (104) is collected in a wet-scrubber (110), wherein the gaseous sulfur dioxide (104) is contacted with an alkaline sorbent (108) in the presence of water, preferably recycled wastewater (140). Preferably, the alkaline sorbent (108) may include limestone, lime, seawater, caustic soda (sodium hydroxide), or any combination thereof. Preferably, the alkaline sorbent comprises limestone and/or lime. In the wet-scrubber (110), the gaseous sulfur dioxide (104) reacts with calcium salt, preferably calcium carbonate, producing an aqueous slurry comprising calcium sulfite (CaSO₃, 106).

The calcium sulfite slurry (106) is then fed into an oxidation reactor (116) wherein calcium sulfite is reacted with compressed air (118), producing the unwashed FGD gypsum slurry (CaSO₄·2H₂O, 114) in the following chemical reaction:

2CaSO₃+4H₂O+O₂→2(CaSO₄·2H₂O)

This unwashed FGD gypsum slurry (114) comprises one or more chlorides, including any one of the following: chloride ions (Cl⁻) and/or various chloride salts, including, but not limited to, calcium chloride, magnesium chloride, sodium chloride and/or potassium chloride (KCl).

The unwashed FGD gypsum slurry (114) is removed from the oxidation reactor (116) and may be allowed to dry. In some embodiments, the unwashed FGD gypsum slurry (114) may be then concentrated and dewatered, for example by filtering water out on a vacuum dewatering belt (126) such that dry unwashed FGD gypsum (128) comprising one or more chlorides is produced. In preferred embodiments and prior to dewatering, the unwashed FGD gypsum slurry (114) may be concentrated and separated from the residual alkaline sorbent (108). The concentration and separation step may be performed in a hydrocyclone (120) or any other similar machine which separates concentrated unwashed FGD gypsum slurry (122) from wastewater (124) and the residual alkaline sorbent, by using centrifugation force, but other filtrations and/or centrifugation systems and devices may be also used. The concentrated unwashed FGD gypsum slurry (122) removed from the hydrocyclone (120) comprises a chloride, including chloride ions and/or one or more chloride salts such as for example as calcium chloride, magnesium chloride, sodium chloride, and/or potassium chloride.

The concentrated unwashed FGD gypsum slurry (122) may be dewatered on a vacuum dewatering belt or by any other method (126), producing unwashed dewatered FGD gypsum (128), comprising chlorides, preferably the chlorides being in the form of one or more chloride salts which may include calcium chloride, magnesium chloride, sodium chloride, and/or potassium chloride. In the drying-type joint compound compositions and methods according to this disclosure, the unwashed FGD gypsum (114, 122 and/or 128) which comprises chlorides is particularly preferred. The unwashed dry FGD gypsum (128) may comprise total chloride (calculated as chloride ion) in amounts of at least about 500 PPM of chloride or higher, e.g. about 600 PPM to about 20,000 PPM, about 500 PPM to about 10,000 PPM, about 600 PPM to about 5,000 PPM, or about 1,000 PPM to about 20,000 PPM of chloride. In some embodiments, the chloride-containing FGD gypsum according to this disclosure may contain from about 0.04 to about 1.5 wt % chloride, preferably from about 0.04 to about 1 wt % or from about 0.5 to about 3 wt % of chloride.

The total concentration of chloride in the unwashed FGD gypsum may be measured by using the following ion chromatography method. An ion chromatography system (ICS), preferably DIONEX-ICS 6000 HPIC system from ThermoFisher, USA, may be used to measure dissolved concentrations of common cations and anions. In embodiments, a test sample was prepared by having synthetic gypsum particles added to water to make a total suspended solid concentration of 10.7% and stirred to dissolve soluble ions. The suspension was then syringe-filtered through a 0.45-μm-pore-sized Pall IC (Ion Chromatography) acrodisc and diluted by a factor of 11. Lastly, the prepared solution was injected into the Dionex-ICS 6000 HPIC for analysis. The following conditions were used, as shown in Table A below.

TABLE A
Dionex ICS 6000 Chromatographic Conditions:

| IC Components | Cations | Anions |
|---|---|---|
| IonPac Columns | CS19(4 × 250 mm)/ | AS25 (4 × 250 mm)/ |
| | CG19 | AG25 |
| | (4 × 50 mm) | (4 × 50 mm) |
| Eluent, flow rate | Methanesulfonic acid | KOH, 1.0 ml/min |
| | (MSA), 0.9 ml/min | |
| Elution | Isocratic 8 mM | Gradient, 15-60 mM |
| Detector | Conductivity | Conductivity |

Chromatography elution peaks were analyzed, using the manufacturer's software.

Conventional methods for producing wallboard-grade FGD gypsum may require additional washing and/or grinding procedures during which the unwashed FGD gypsum slurry (122) or the unwashed dry FGD gypsum (128) is washed with additional amounts of water, preferably recycled water (140) in a vacuum filtering system (132) which may be combined with the dewatering system (126), in order to remove chlorides and water-soluble salts. The washed FGD gypsum (138) contains only minimal amounts of chlorides and water-soluble salts, preferably equal or less than about 120 PPM of the chloride ions. In some embodiments, the washed dried FGD gypsum (138) may comprise about 120 PPM to about 500 PPM of chloride. While the washed dried FGD gypsum (138) may be used in some drying-type joint compound compositions according to this disclosure, the unwashed FGD gypsum (114, 122 or 128) is preferable in part because during the washing process in order to produce the washed dried FGD gypsum (138), additional large amounts of wastewater, which can be referred interchangeably as effluent solution, (124) are generated. All wastewater (124) must be treated at a wastewater treatment station (136) in order to produce recycled water (140) which can be safely disposed of or reused in the scrubber (110) and/or during washing at the vacuum filtering station (132), as described above.

Unlike conventional compositions and methods which comprise a step of removing chlorides from FGD gypsum by washing, the compositions and methods according to this disclosure may utilize either directly or with subsequent processing steps, the unwashed FGD gypsum slurry (114) and/or the unwashed FGD concentrated gypsum slurry (122) or the unwashed dry FGD gypsum (128), without the need for a step of washing and removing chlorides and without the need to produce the washed FGD gypsum (138). Thus, the compositions and methods according to this disclosure provide a technical advantage of reducing amounts of wastewater and further they decrease a cost of production in part because less wastewater is produced.

In some preferred embodiments, the drying-type joint compounds according to this disclosure may comprise unwashed FGD gypsum containing water-soluble chloride salts and/or chloride ions in concentrations higher, preferably at least by two-folds or more, than concentrations of soluble chloride salts and chloride ions in the washed FGD gypsum (138). In some preferred embodiments, the unwashed FGD gypsum according to this disclosure may comprise at least about 500 PPM, at least about 600 PPM or at least about 1,000 PPM of chloride, or higher, e.g. from about 500 PPM to about 20,000 PPM, preferably from about 1,500 PPM to about 4,000 PPM and more preferably from about 1,000 PPM to about 10,000 PPM of chloride.

With reference to FIG. 5, one embodiment of a method for producing the FGD gypsum according to this disclosure, generally (200), may comprise, consist essentially of, or consist of the following steps (202) through (206). In the oxidation step (202), an aqueous slurry comprising calcium sulfite (CaSO₃) is reacted with compressed air in an oxidation reactor, producing the unwashed FGD gypsum slurry comprising one or more chlorides, including any one of the following: chloride ions (Cl⁻) and/or various chloride salts, including, but not limited to, calcium chloride, magnesium chloride, sodium chloride, potassium chloride or any combination thereof.

In the drying step (204), the unwashed FGD gypsum slurry may be concentrated, dewatered, dried and/or separated from a residual sorbent, producing dry FGD gypsum comprising one or more chlorides, including any one of the following: chloride ions (Cl⁻) and/or various chloride salts, including, but not limited to, calcium chloride, magnesium chloride, sodium chloride and/or potassium chloride.

Optionally, in the grinding step (206), the dry unwashed FGD gypsum comprising one or more chlorides from step (204) may be ground and/or subsequently fractioned according to particle sizes in order to produce the dry FGD gypsum comprising one or more chloride salts, said FGD gypsum having a D50 value of about at least about 20 μm, more preferably at least about 30 μm, and most preferably at least about 40 μm, as measured with a dynamic light scattering analyzer.

It was found that a suitable ready mixed joint compound can be made with the unwashed FGD gypsum, also referred to as unwashed synthetic gypsum or unwashed syn gyp. Using the unwashed FGD gypsum in joint compounds is an unexpected result because the main user of FGD gypsum was previously the wallboard industry which utilizes washed FGD gypsum because a high-salt content may be detrimental to the quality of wallboard and therefore, the unwashed FGD gypsum is unlikely to be used by the wallboard industry, absent additional processing for removing chloride salts.

This new use in joint compounds, as reported in this disclosure, for previously mostly not useful unwashed FGD gypsum may allow power plants to reduce a frequency of blowdowns, reduce or eliminate a washing procedure for the FGD gypsum, and reduce a volume of generated wastewater (effluent solution). This new use in joint compounds is greener, helps coal-power plants in achieving a zero discharge and saves time and resources. Furthermore, using this high-loading level of salts, preferably as chloride salts, proves that seawater may be used to make ready-mixed joint compounds with either gypsum and/or carbonate fillers as a main component, providing a further saving of water.

Currently, wastewater treatment by power plants includes multiple steps with consumables which add to costs; clarification, de-salination, trace metal precipitation, aeriation, biological reduction, disinfection and filtration. For most applications, a usage of high-salt containing gypsum may require the user to wash the material and dewater it. However, the subject of this invention eliminates or reduces the need for washing the FGD gypsum and instead provides compositions and application methods with chloride-containing FGD gypsum which may have concentrations of chloride as higher as about 0.04-5 wt % at least in some embodiments.

Natural gypsum for construction is traditionally processed in a method which includes excavating gypsum mineral from the earth crust, crushing the gypsum mineral into gypsum fragments, preferably to a size of 20-30 mm, and then grinding the gypsum fragments until gypsum powder with the median size distribution (D50) of about 15 μm is obtained, which is a preferred size of ground gypsum for construction formulations because the finer the grinding, the larger is the reaction surface of ground gypsum and the faster is the setting reaction of calcined gypsum. It was reported in U.S. Pat. No. 3,723,146 that having calcined gypsum that is substantially free of plus 32 micron particles improves significantly resistance to aging and produces a faster setting reaction.

However, one of technical disadvantages of drying-type joint compounds which comprise gypsum is that these joint compounds are difficult to sand.

This disclosure provides a technical solution to this problem, wherein these inventors have unexpectedly discovered that a drying-type joint compound with a technically acceptable friction coefficient of about 1.25 or lower, preferably of about 1.20 or lower, and most preferably of about 1.15 or lower, can be obtained by controlling particle size distribution in gypsum, including the FGD gypsum which is preferably unwashed and comprises chlorides, including chloride ions in concentrations preferably of about 500 PPM or higher. In order to control the particle size distribution in gypsum, a grinding and/or subsequent fractionation of the gypsum powder according to particle sizes may be used such that a gypsum powder is produced which has a D50 value of about at least 20 μm or greater, e.g. at least equal or greater than 24, 31, 62, or 78 μm. The gypsum powder preferably also has a D10 value greater than about 5 μm.

This disclosure relates to a drying-type joint compound composition containing gypsum powder, preferably including the FGD gypsum which comprises chloride ions, including chloride ions in concentrations preferably of about 500 PPM or higher, with a particle size distribution optimized for lowering a friction coefficient of a drying-type joint compound.

Preferably, the gypsum powder has D50 of about 20 μm or greater, e.g., of at least about 21 μm or greater, at least about 22 μm or greater, at least about 24 μm or greater, for example in the range from about 20 μm to about 80 μm, or in the range from about 21 μm to about 75 μm. In preferred embodiments, the gypsum powder also has a D10 greater than 5 μm, e.g., equal or greater than 6 μm, 7 μm, 8 μm, 9 μm, 10 μm or 11 μm. In some embodiments, the gypsum powder is substantially free of fine particles with a particle size ranging from about 0.1 μm to about 10 μm, or more preferably ranging from about 0.1 μm to about 5 μm. In preferred embodiments, the gypsum powder may also have a D90 equal or less than about 130 μm, e.g., equal or less than about 96 μm, 90 μm, 89 μm, 88 μm, 87 μm, 86 μm, or 85 μm.

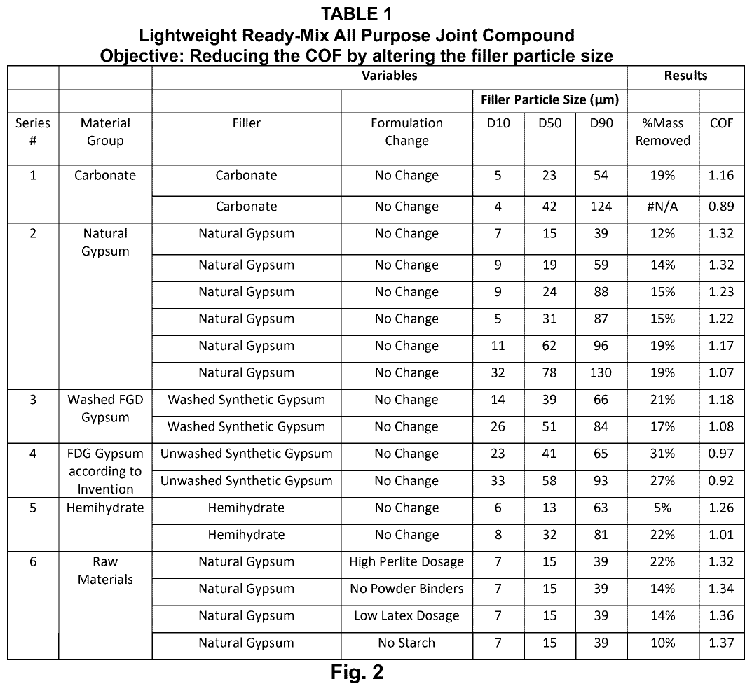

Some embodiments of the gypsum powders according to this disclosure are listed in Table 1 of FIG. 2, including certain embodiments of joint compounds made with powders in series 2 and 3 and more preferably in series 4 with the unwashed FGD gypsum having the coefficient of friction of less than 1. Certain preferred unwashed FGD gypsum powders which comprise chlorides may have the following particle size distributions: D10 in the range of about 23-33; D50 in the range of about 41-58; and D90 in the range of about 65-93, as shown in FIG. 2.

Before this disclosure, it was generally believed in the construction field that gypsum is not suitable even in small amounts as a filler for a drying-type joint compound in part because such drying-type joint compounds are more difficult to sand. In contrast to the general belief, it has been now unexpectedly found that a drying-type joint compound with a lowered friction coefficient can be prepared with a FGD gypsum powder which has been produced such that production of fine particles is avoided during crushing/grinding and/or the ground gypsum powder has been fractionated according to particle sizes such that fine particles, including those in the range from about 0.1 μm to about 5 μm, have been removed from the gypsum powder.

Grinding is an optional step in preparation of FGD gypsum in part because the FGD gypsum powder having the D50 value of 20 μm or greater may be obtained by the methods according to this disclosure without grinding. In some embodiments, FGD gypsum may be prepared without grinding. However, if necessary, FGD gypsum can be processed by using a grinding machine in some embodiments. Examples of grinding machines include, but are not limited to, a ball mill, impact mill and/or a roller mill. Preferably, a tumbling mill grinding machine, or a ball mill can be used, if necessary.

Suitable gypsum particle fractionation techniques which can be used include, but are not limited, to inertia based, centrifugal, and/or residence time-based techniques, such as turbines, whizzer air separators, cyclones which can control and remove a particulate matter from the gypsum powder according to particle size, elbow jet air classifiers which can classify gypsum particles into several products simultaneously based on the particle size.

In addition to a grinding procedure aiming at producing the gypsum powder having the D50 value of 20 μm or greater, a step of fractionation according to particle size may be also performed. The fractionation aiming at separation and removal of fine particles may be performed in a turbine, with a whizzer air separator, a cyclone, or an elbow jet air classifier. The size fractionation step may also include passing gypsum powder through a sieve such that only fine particles are passed through the sieve openings and these fine particles are thereby separated and removed from a gypsum powder fraction retained on the sieve.

In order to measure a particle size distribution in FGD gypsum, a person of skill may use a particle size analyzer such as a dynamic light scattering analyzer such as for example as Horiba LA950V2 dynamic light scattering analyzer (Horiba, Japan) and isopropyl alcohol as dispersant.

In embodiments, the gypsum powder may be fractionated by using a U.S. standard Sieve 625 Mesh (20 μm openings), 450 Mesh (32 μm openings), wherein gypsum to be fractioned is passed through a U.S. 625 Mesh or 450 Mesh and the gypsum powder which is retained on the mesh is collected and is the gypsum powder according to this disclosure.

U.S. standard Mesh Size is defined as the number of openings in one square inch of a screen. U.S. 625 Mesh has 625 openings per one square inch, U.S. 450 Mesh has 450 openings per one square inch and U.S. 325 Mesh has 325 openings in one square inch. The gypsum powder according to this disclosure may be noted with a minus (−) or plus (+) sign. If the minus (−) sign is used, it denotes that particles in the gypsum powder are smaller than the mesh size. If the plus (+) sign is used, it denotes that most of particles in the gypsum powder are larger than the mesh size. For example, +450 mesh gypsum powder indicates that at least 90% of particles in the gypsum powder are larger than 32 μm. The same gypsum powder may be referred to as plus 32 μm gypsum powder.

In some preferred embodiments, the gypsum powder may substantially consist of at least 80% and preferably at least 90% of particles sizing in the range from about 350 μm to about 5 μm, and more preferably the gypsum powder may substantially consist of or consist of 90% or 80% of particles with sizes in the range from about 200 μm to about 5 μm.

Referring to Table 1 in FIG. 2, it reports friction coefficients for drying type joint compounds prepared with a filler comprising gypsum having D50 of about 15μ versus drying type joint compounds prepared with the gypsum powder according to this disclosure and having a D50 value of about 20μ or greater. As a control, samples in series 1 were prepared with calcium carbonate as a filler. As can be seen in FIG. 2, using gypsum having a D50 value of about 15 μm increases a friction coefficient unfavorably in comparison to a drying-type joint compound comprising calcium carbonate, from 1.16 to 1.32. This unfavorable increase in the friction coefficient cannot be efficiently remedied by adding various amounts of light-weight filler perlite (series 6) or by changing a formulation of a binder (series 6). In contrast, the gypsum powder according to this disclosure having a D50 value of at least 24 μm or greater produces a drying-type joint compound with a friction coefficient which is lower than that of a joint compound formulated with gypsum having D50 of 15 μm (series 2 or series 4 versus control joint compound formulations in series 1). A joint compound prepared with the gypsum powder according to this disclosure, including series 3 or 4 in FIG. 2, has an acceptable friction coefficient which is comparable or even lower than a friction coefficient of a joint compound prepared with calcium carbonate.

In some preferred embodiments, the friction coefficient of a joint compound formulated with the gypsum powder according to this disclosure has been lowered by at least about 5%, about 10% and more preferably by at least 15% and most preferably by at least 20% in comparison to a joint compound prepared with gypsum having the median particle size (D50) of about 15 μm.

Still referring to FIG. 2, it has been further unexpectedly found that the unwashed FGD gypsum can be used for obtaining a drying-type joint compound with a friction coefficient lower than 1.00 even with a powder in which D90 is 93, as shown in series 4.

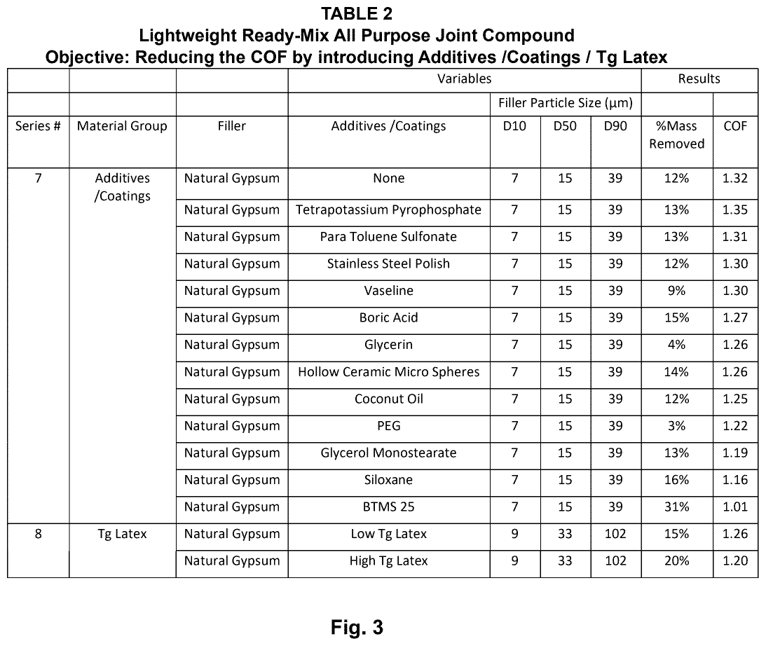

The drying-type joint compounds according to this disclosure, including those reported in Table 1 of FIGS. 2 and Table 2 of FIGS. 3, may comprise from about 25 wt % to about 95 wt %, more preferably 35 wt % to 85 wt %, or 60 wt % to 75 wt % on a dry basis of the gypsum powder according to this disclosure, which in some preferred embodiments, may be FGD gypsum and more preferably the FGD gypsum which comprises at least 500 PPM or higher of chloride ions, including the unwashed FGD gypsum produced according to embodiments of FIGS. 4 and 5.

Thus, the gypsum powder of this disclosure can be used as a main filler and in large amounts because the friction coefficient has been optimized and is comparable or even lower than a friction coefficient of a drying-type joint compound which comprises calcium carbonate. In some embodiments, a drying-type joint compound may be prepared without calcium carbonate (limestone). In other embodiments, a drying-type joint compound may include calcium carbonate. In some other embodiments, a drying-type joint compound may be prepared with a combination of the gypsum powder and calcium carbonate. In some embodiments, the drying-type joint compound may comprise a mixture of the gypsum powder together with calcium carbonate in an amount ranging from 50 wt % to about 95 wt %, more preferably 55 wt % to 85 wt %, or 60 wt % to 80 wt % on a dry basis of the dry-type joint compound composition. Calcium carbonate to the gypsum powder may be used in a ratio ranging from 1:10 to 10:1 by weight, respectively.

Preferably, drying-type joint compounds according to this disclosure do not comprise calcined gypsum.

In addition to the gypsum powder and/or the gypsum powder and calcium carbonate as the main filler, some formulations of the dry-type joint compounds according to this disclosure may further comprise a second filler which may be preferably a light-weight filler comprising one or more of the following: perlite, expanded perlite, coated expanded perlite, mica, hollow glass microspheres, talc, polyethylene hollow microspheres, ceramic microspheres, solid glass microspheres, plastic microspheres, or any mixture thereof.

In embodiments, the light-weight fillers may be used in any suitable amounts, depending on the filler type. Preferably, from about 0.1 wt % to about 25 wt %, more preferably from about 0.5 wt % to about 20 wt % and most preferably from about 1 wt % to about 15 wt % of the light-weight filler on a dry basis may be used in at least some embodiments.

One particularly preferred light-weight filler is perlite which can be used as expanded perlite. Perlite may be coated or uncoated. Suitable coatings include silane or siloxane coatings, including as described in U.S. Pat. Nos. 4,454,267 and 4,525,388.

The drying-type joint compounds according to this disclosure may comprise at least one binder. Suitable binders include natural starches produced from plants, synthetic starches, polymeric binders, or any combination hereof. Non-limiting examples of starches are corn, wheat, and potato starch. Starches include those that have been chemically modified and/or pregelatinized. In at least some embodiments, about 0.1 wt % to about 10 wt % of starch, preferably about 0.1 wt % to about 3 wt %, calculated on a dry basis of the joint compound, may be used.

Examples of suitable polymer binders include, but are not limited to, polyvinyl acetate, polyvinyl alcohol, acrylic emulsions, vinyl or styrene acrylic co-polymers, ethylene vinyl acetate co-polymer, polyacrylamide, or any combination thereof. In embodiments, one or more binders may be included in an amount ranging from about 0.5 wt % to about 15 wt %, preferably from about 4 wt % to about 10 wt %, on a dry basis of the joint compound composition.

In some preferred embodiments, a latex emulsion such as for example as ethylene vinyl acetate or polyvinyl acetate emulsion, may be used either alone or in combination with other polymer binders. In some embodiments, from about 1 wt % to about 10 wt %, or from about 1 wt % to about 5 wt % of a latex emulsion on a dry basis of the joint compound may be used.

As reported in Table 2 of FIG. 3, it has been further found that latex binders with a low glass transition temperature (low T_{g}) and/or a high glass transition temperature (high T_{g}) are suitable for drying-type joint compound compositions. However, using a latex binder with a high glass transition temperature may lower a friction coefficient further in the compositions according to this disclosure in comparison to the same compositions, but in which a latex binder with a low glass transition temperature has been used. Preferably, latex binders with high T_{g} include those having a T_{g} in the range from about 30 to about 60° C. Preferably, latex binders with low T_{g} include those having a T_{g} in the range from about 10 to about 25° C.

The drying-type joint compounds according to this disclosure may comprise at least one non-leveling agent, which may be attapulgite clay, bentonite, a starch, e.g., corn starch, or any combination thereof. Preferably, the drying-type joint compounds according to this disclosure comprise attapulgite clay and more preferably attapulgite clay in combination with kaolin clay. The non-leveling agents may be used in small amounts, for example in any amount ranging from about 0.5 wt % to about 10 wt %, or more preferably from about 1 wt % to about 5 wt % on a dry basis of the joint compound composition. In some preferred embodiments, attapulgite clay may be used in an amount from about 0.5 wt % to about 5.0 wt % and more preferably from about 1 wt % to about 3 wt %. In some embodiments, attapulgite clay may be used in combination with kaolin clay which may be used in small amounts of about 3 wt % or less, preferably from about 0.5 wt % to about 2 wt %, on a dry basis of the joint compound composition.

Drying-type joint compounds according to this disclosure may comprise one or more of cellulosic thickeners. Examples of suitable cellulosic thickeners include, but are not limited to, cellulose ethers in which the secondary hydroxyls of cellulose are replaced by ether groups, such for example as hydroxyethyl cellulose, hydroxypropyl methylcellulose, ethylcellulose, carboxymethyl cellulose, ethyl methylcellulose, among many others; as well as various cellulose-based gums, e.g., carrageenan, guar gum, and/or xanthan gum. The cellulosic thickener may be present in any amount ranging from about 0.05 wt % to about 3 wt %, preferably from about 0.1 wt % to about 2 wt % on a dry basis of the joint compound composition. In some embodiments, one or more cellulosic thickeners may be used in amount ranging from about 0.1 to about 0.5 wt % and more preferably from about 0.1 to about 0.4 wt % on a dry basis of the joint compound composition.

The drying-type joint compound compositions according to this disclosure may further comprise one or more low molecular weight polymeric rheology modifiers, including one or more of alkali-swellable (ASE) acrylic polymers and/or hydrophobically modified alkali swellable (HASE) acrylic co-polymers. The ASE polymeric rheology modifiers include co-polymers of methacrylic acid and acrylic ester in which thickening may be triggered by a change from low to high pH. The HASE polymeric rheology modifiers include co-polymers of acrylic acid and one or more of second associative monomers which may contain a hydrophilic chain segment linked with a terminal hydrophobic group. The ASE and/or HASE rheological modifiers may be used in small amounts, preferably from about 0.01 wt % to about 10 wt %, about 0.1 wt % to about 5.0 wt %, or about 0.1 wt % to about 1 wt % on a dry basis of the joint compound composition. In some embodiments, the ASE and/or HASE rheological modifiers may be used in an amount ranging from about 0.1 wt % to about 3 wt % and more preferably from about 0.5 wt % to about 2 wt % on a dry basis of the joint compound composition.

The drying-type joint compounds according to this disclosure may further comprise one or more of other additives, including, but not limited to, a biocide, a pigment, a fungicide, a dispersing agent, a humectant, a defoaming agent, a plasticizer, a dedusting agent, or any combination thereof. Some of the additives may be a polymeric additive selected from one or more of the following: a surfactant, redispersible powdered latex, dispersing agent, humectant, defoaming agent, a plasticizer, polyethylene oxide, a phospholipid, or any combination thereof. If present, any of these additives may be used in small amounts, such as for example as from about 0.1 wt % to about 2 wt % on a dry basis of the joint compound composition.

In some embodiments, the composition may comprise from about 0.1 wt % to about 0.5 wt % of a biocide and/or from about 0.1 wt % to about 5 wt %, more preferably from about 1.5 wt % to about 2.5 wt % of mica.

Particularly preferred additives include those which may be used to further decrease a friction coefficient of the drying-type joint compound according to this disclosure. The dedusting additives may include a wax, oil, polyethylene glycol (PEG), glycerol, or any combination thereof.

As reported in FIG. 3, particularly preferred dedusting agents include, but are not limited to, coconut oil, glycerol monostearate, or siloxane. As shown in FIG. 3, these compounds may lower a friction coefficient of a drying-type joint compound comprising gypsum even with D50 of about 15 μm. Particularly suitable examples of glycerol include, but are not limited to, ethylene glycol, propylene glycol, diethyl glycol, or any combination thereof. Any of these dedusting agents may be used in an amount ranging from about 0.1 wt % to about 1 wt % on a dry basis of the joint compound composition.

In some embodiments, the drying-type joint compounds according to this disclosure may be prepared as a dry powder composition which is then mixed with water prior to use. Water, which may be seawater in some embodiments, can be added in any amount suitable to produce a paste-like consistency. Preferably, water may be used in a weight ratio of water to dry components of the joint compound in the range from about 1:6 to about 1:1, respectively.

In other embodiments, the drying-type joint compounds according to this disclosure may be prepared as ready-mixed paste formulations. In these embodiments, the dry components are premixed with water and allowed to be stored as a premixed composition. One embodiment of a ready-mixed joint compound according to this disclosure is listed in Table 3 below.

TABLE 3
Ready-Mixed Joint Compound Composition

| | | | Most |
|---|---|---|---|
| | | | Preferred |
| | Percent | Percent | Percent |
| Raw Material | (%) | Range (%) | Range (%) |
| Gypsum with D50 at least | 43.60% | 25.0-67.0% | 35.0-62.0% |
| 20 μm, preferably FGD | | | |
| gypsum, and optionally in | | | |
| combination with calcium carbonate | | | |
| Mica | 2.00% | 0.0-5.0% | 1.5-2.5% |
| Perlite | 5.80% | 0.0-10.0% | 4.0-8.0% |
| Attapulgite Clay | 1.60% | 0.5-5.0% | 1.0-3.0% |
| Kaolin Clay | 0.80% | 0.0-3.0% | 0.5-2.0% |
| Cellulosic Thickener | 0.40% | 0.0-0.6% | 0.1-0.5% |
| Acrylic Rheological Modifier | 1.80% | 0.0-3.0% | 0.5-2.0% |
| Latex Emulsion | 1.00% | 0.0-5.0% | 1.0-4.0% |
| Polymeric additive selected | 0.40% | 0.0-2.0% | 0.1-0.5% |
| from one or more of the | | | |
| following: surfactant, | | | |
| redispersible powdered latex, | | | |
| dispersing agent, humectant, | | | |
| defoaming agent, a plasticizer, | | | |
| polyethylene oxide, a phospholipid | | | |
| or any combination thereof. | | | |
| Starch | 0.30% | 0.0-3.0% | 0.1-1.0% |
| Optionally, Biocide | 0.40% | 0.0-0.5% | 0.1-0.5% |
| Water | 40.90% | 25.0-55.0% | 30.0-45.0% |
| Chloride Salts (CaCl₂ + MgCl₂ 6H₂O + NaCl + KCl) | 1.00% | 0.0-3.0% | 1.0-2.0% |
| Total | 100.00% | 100.00% | 100.00% |

In another aspect, this disclosure relates to methods of using joint compounds according to this disclosure. The joint compounds according to this disclosure include all-purpose joint compounds, taping joint compounds, and finishing joint compounds and they can be used for finishing seams (joints) between adjacent wallboard panels and/or to prepare or repair a wallboard surface. After the drying-type joint compound is applied to a surface, the drying-type joint compound is allowed to dry. After the joint compound has sufficiently dried, it can be sanded, preferably dry sanded, but wet sanding and/or sponging can be also used. In embodiments, sanding can be performed with sandpaper, optionally with a vacuum attachment.

The joint compounds according to this disclosure may be used in any of the following applications among others: 1) repairing minor damages on a wallboard surface, e.g., holes, dents, and scares; and 2) preparing a wallboard surface wherein the joint compound can be applied over the surface as a skim coating. The joint compounds can be also used to finish wallboard panel joints and/or to mask corner beads, joint tape and fasteners.

The invention will now be further described with the following non-limiting examples.

### Example 1

For high levels of chloride, seawater was used as a reference, and that level was selected as the maximum chloride content of about 19,500 PPM chloride in gypsum powder for a drying-type joint compound composition in experimentation.

Levels of chloride from several soluble chloride salts were evaluated at the following levels as shown in Table 4.

TABLE 4

| Salt | Chloride, PPM | Salt, PPM |
|---|---|---|
| CaCl₂ | 11000 | 17218.3 |
| CaCl₂ | 19500 | 30523.4 |
| MgCl₂ × 6H₂O | 11000 | 28735.0 |
| MgCl₂ × 6H₂O | 19500 | 50939.3 |
| NaCl | 11000 | 18133.7 |
| NaCl | 19500 | 32146.1 |
| KCl | 11000 | 23132.6 |
| KCl | 19500 | 41007.8 |

TABLE 5
Chloride Levels in Unwashed FGD
Gypsum versus Washed FGD Gypsum

| | | Dewatered, | | Total |
|---|---|---|---|---|
| | Effluent | dried FGD | | Soluble |
| Reference | Solution | Gypsum Cl⁻, | NaCl, | Salts, |
| Levels | Cl⁻, PPM | PPM | PPM*** | PPM* |
| Concentration | | 123 | 203 | 252 |
| in washed | | | | |
| dried FGD | | | | |
| Gypsum | | | | |
| Corrodible | 12000 | 10800 | 17797 | 19468 |
| Scrubbers, | | | | |
| Max | | | | |
| Corrosion | 35000 | 31500 | 51908 | 56722 |
| Resistant | | | | |
| Scrubbers, | | | | |
| Max | | | | |

| Tested | | | NaCl, | Total Soluble Salts, |
|---|---|---|---|---|
| Levels | | Cl⁻, PPM | PPM*** | PPM* |
| Low- | — | 500 | 303 | 577 |
| concentration | | | | |
| salt gypsum | | | | |
| powder | | | | |
| Medium- | — | 2500 | 4120 | 7445 |
| concentration | | | | |
| salt gypsum | | | | |
| powder | | | | |
| High- | — | 19500 | 32134 | 36547 |
| concentration | | | | |
| salt gypsum | | | | |
| powder | | | | |

*Approximated from liner regression of 12-month data, R-Square 0.9599
**Assuming 35000 ppm chloride in oxidizer reactor blow down and 10% free water in dewatered FGD gypsum, 12000 ppm for corrodible reactors
***Stoichiometrically

We claim:

1. A drying-type joint compound composition comprising:
a) chloride-containing flue-gas-desulfurization (FGD) gypsum powder having the median particle size (D50) of at least about 20 μm;
b) a binder;
c) one or more clays;
d) a cellulosic thickener; and
e) an additive.

2. The drying-type joint compound composition of claim 1, wherein the median particle size (D50) is measured in a dynamic light scattering analyzer and wherein the drying-type joint compound composition when mixed with water and allowed to dry has a friction coefficient lower than a friction coefficient of a drying-type joint compound comprising natural gypsum having the median particle size (D50) of about 15 μm.

3. The drying-type joint compound composition of claim 1, wherein the chloride-containing FGD gypsum powder comprises one or more of the following chloride salts: calcium chloride, magnesium chloride, sodium chloride, potassium chloride and/or any combination thereof.

4. The drying-type joint compound composition of claim 1, wherein the chloride-containing FGD gypsum powder contains from about 500 PPM to about 20,000 PPM of chloride.

5. The drying-type joint compound composition of claim 1, wherein the chloride-containing FGD gypsum powder is obtained by a method comprising:
a) oxidizing an aqueous chloride-containing slurry comprising calcium sulfite into chloride-containing FGD gypsum slurry, and
b) dewatering the chloride-containing FGD gypsum slurry produced in step a) into dewatered chloride-containing FGD gypsum, and
wherein the method is performed without a step of lowering the chloride concentration.

6. The drying-type joint compound composition of claim 5, wherein the method further comprises removing fine particles from the chloride-containing FGD gypsum powder.

7. The drying-type joint compound composition of claim 1, wherein the additive includes a polymeric additive selected from one or more of the following: a surfactant, redispersible powdered latex, dispersing agent, humectant, defoaming agent, a plasticizer, polyethylene oxide, a phospholipid, or any combination thereof.

8. The drying-type joint compound composition of claim 1, wherein the chloride-containing FGD gypsum powder has the D50 value in the range from about 20 μm to about 80 μm.

9. The drying-type joint compound composition of claim 1, wherein
the chloride-containing FGD gypsum powder is in an amount ranging from about 50 wt % to about 95 wt % on a dry basis of the drying-type joint compound composition; or
the drying-type joint compound composition further comprises calcium carbonate, and wherein the chloride-containing FGD gypsum powder together with calcium carbonate comprise from about 50 wt % to about 95 wt % on a dry basis of the dry-type joint compound composition.

10. The drying-type joint compound composition of claim 1, wherein the drying-type joint compound composition comprises on a dry basis:
about 50 wt % to about 95 wt % of the FGD gypsum powder;
about 0.5 wt % to about 15 wt % of the binder;
about 1 wt % to about 10 wt % of the one or more clays;
about 0.05 wt % to about 3 wt % of the cellulosic thickener; and
about 0.1 wt % to about 3 wt % of the additive comprising one or more of the following: acrylic rheological modifier, biocide, pigment, fungicide, dispersing agent, humectant, defoaming agent, plasticizer, dedusting agent, starch, or any combination thereof.

11. The drying-type joint compound composition of claim 1, wherein the drying-type joint compound composition further comprises one or more of the following light-weight fillers: perlite, expanded perlite, coated expended perlite, mica, hollow glass microspheres, talc, polyethylene hollow microspheres, ceramic microspheres, solid glass microspheres, plastic microspheres, or any mixture thereof.

12. The drying-type joint compound composition of claim 11, wherein the one or more of the light-weight fillers are used in an amount from about 0.5 wt % to about 25 wt % on a dry basis of the drying-type joint compound.

13. The drying-type joint compound composition of claim 1, wherein the chloride-containing FGD gypsum powder comprises about 0.04 wt % to about 1.5 wt % chloride by weight.

14. The drying-type joint compound composition of claim 1, wherein the drying-type joint compound composition further comprises one or more of the following dedusting agents: a wax, oil, polyethylene glycol, glycerol, siloxane, or any combination thereof.

15. The drying-type joint compound of claim 1, wherein the binder is a latex binder with a high glass transition temperature (T_{g}).

16. The drying-type joint compound composition of claim 1, wherein the drying-type joint compound composition further comprises one or more of ASE and/or HASE rheological modifiers.

17. A ready-mixed drying-type joint compound, wherein the ready-mixed drying-type joint compound comprises the drying-type joint compound composition of claim 1 and water in the following amounts:
about 25.0-67.0 wt % of the chloride-containing FGD gypsum powder containing about 0.04-1.5 wt % of chloride;
about 0.1-5.0 wt % of the binder;
the one or more clays comprising about 0.5-5.0 wt % attapulgite clay and about 0.1-3.0 wt % of kaolin clay;
about 0.1-0.6 wt % of the cellulosic thickener;
about 0.1-2.0 wt % of the additive; and
about 25.0-55.0 wt % water.

18. The ready-mixed drying-type joint compound of claim 17, wherein the water is seawater.

19. A method for producing flue-gas-desulfurization (FGD) gypsum powder for use in a drying-type joint compound, the method comprising: dewatering a slurry comprising chloride-containing FGD gypsum into dewatered chloride-containing FGD gypsum, wherein the resulting chloride-containing FGD gypsum powder contains from about 500 PPM to about 20,000 PPM of chloride.
